(19) United States
(12) Patent Application Publication
(10) Pub. No.: US 2024/0029051 A1
(43) Pub. Date: Jan. 25, 2024

(54) Real-Time Functionality Modification Based on Dynamically Generated Device Identifier

(71) Applicant: Bank of America Corporation, Charlotte, NC (US)

(72) Inventors: Maneesh Sethia, Hyderabad (IN); Saurabh Garg, Faridabad (IN)

(21) Appl. No.: 17/872,423

(22) Filed: Jul. 25, 2022

(51) Int. Cl. G06Q 20/32; G06Q 20/38; G06Q 20/40

(52) U.S. Cl. CPC G06Q 20/3278; G06Q 20/389; G06Q 20/4015; G06Q 20/4016

(57) ABSTRACT

Arrangements for providing dual-functionality device control functions are provided. In some aspects, a selection of a mode of functionality may be received. For instance, a user may select an option of at least two options available for selection on the payment device. In response to receiving the selected mode, a device identifier that may be or include a non-fungible token (NFT) may be generated. The NFT may be transmitted to the payment device for display on the payment device. The payment device may then be used to initiate a transaction. A transaction request including an encrypted version of the NFT, as well as additional data, may be received. The NFT may be decrypted and evaluated to determine whether it matches a pre-stored NFT. If not, the transaction may be denied and if so, the transaction may be authorized.

### BACKGROUND

Aspects of the disclosure relate to electrical computers, systems, and devices for providing real-time functionality modification of a payment device based on a dynamically generated device identifier.

Despite various payment options available, consumer use of physical payment devices, such as debit cards, credit cards, and the like, continues to be extremely common. However, a user may wish to use different payment devices in different scenarios. For instance, for a low cost purchase (e.g., a coffee at a coffee shop) the user may wish to use a debit card to complete the purchase. For higher cost purchases (e.g., a new appliance) the user may wish to use a credit card. Accordingly, in conventional arrangements, having the flexibility to use credit or debit functionality as desired may require the user to carry two payment devices (e.g., a debit card and a separate credit card). Accordingly, aspects described herein use non-fungible tokens and blockchain to provide a single payment device with dual functionality (e.g., either credit or debit) to enable user to select different functionality (in real-time) as desired.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with providing payment devices having different types of functionality.

In some aspects, a selection of a mode of functionality or processing may be received. For instance, a user may select, via one or more selection options on a payment device, a mode of functionality for the payment device. The selected mode may be received and, in response, a device identifier that may be or include a non-fungible token (NFT) may be generated. The NFT may be transmitted to the payment device for display on the payment device.

The payment device may then be used to initiate a transaction. A transaction request including an encrypted version of the NFT, a user identifier retrieved from a smart chip on the payment device, a flag indicating a selected mode of functionality and, in some examples, geo-location data may be received. The transaction request may also include transaction details such as amount, type, and the like. The NFT may be decrypted and evaluated to determine whether it matches a pre-stored NFT, is associated with the user identifier, and the like. If not, the transaction may be denied and a denial may be transmitted to one or more devices including, for instance, the payment device.

If the NFT matches the pre-stored NFT, is associated with the user, and the like, the transaction may be authorized for processing and a notification may be transmitted to one or more devices including, for instance, the payment device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1D depict an illustrative computing environment for implementing dual-functionality device control functions in accordance with one or more aspects described herein;

FIGS. 2A-2E depict an illustrative event sequence for implementing dual-functionality device control functions in accordance with one or more aspects described herein;

FIG. 3 illustrates an illustrative method for implementing dual-functionality device control functions according to one or more aspects described herein;

FIGS. 4 and 5 illustrate example payment devices displaying notifications that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, users who desire to have the flexibility to use debit functionality for some transactions and credit functionality for other transactions may have to carry two separate payment devices (e.g., a debit card and a separate credit card). This can be cumbersome and inefficient. However, carrying only one type of payment device may leave users in situations where a merchant may only accept, for instance, a debit payment (e.g., in cases of low cost purchases, such as under $10).

Accordingly, aspects described herein are directed to providing a single payment device providing both credit functionality and debit functionality. In some examples, the user may select different types of functionality by selecting an option associated with one of at least two types of functionality provided on the payment device. For instance, a payment device, such as a card-type payment device, may include one or more options to dynamically select functionality of the payment device (e.g., debit, credit, or the like). In some examples, the user may select functionality via the payment device (e.g., by selecting an option, button or the like associated with a functionality) and a dynamically generated non-fungible token (e.g., a device identifier) may be generated and, for instance, displayed on a display of the payment device. The non-fungible token, may be encrypted and sent, with additional information, for transaction processing. For instance, a user identifier associated with a user of the payment device may be retrieved from, for instance, a smart chip embedded in the payment device and may include, for instance, a user or party identifier.

In some examples, the payment device may also capture location data (e.g., a longitude and latitude of the current location of the payment device) and this geo-location data may be encrypted and included with the NFT and user identifier.

In some arrangements, the encrypted data and associated data may be transmitted to, for instance, an enterprise organization (e.g., financial institution) for evaluation, authentication and authorization. For instance, the encrypted data may be received by the financial institution and decrypted. In some examples, the user identifier retrieved from a chip on the payment device may be used to determine validity of the decrypted NFT and/or authenticate the user. Further, the geo-location data may be used to evaluate whether unauthorized activity is occurring (e.g., based on historical data, expected location data of the user, or the like).

Upon validating the NFT, user identifier and/or geo-location data, the transaction processing data may be used to process the transaction. In some examples, this may include transmitting transaction processing instructions to one or more external entities (e.g., a credit card provider, other financial institution, or the like). Transaction response data may be received and, ins some examples, transmitted to the payment device for display on the payment device.

These and various other arrangements will be discussed more fully below.

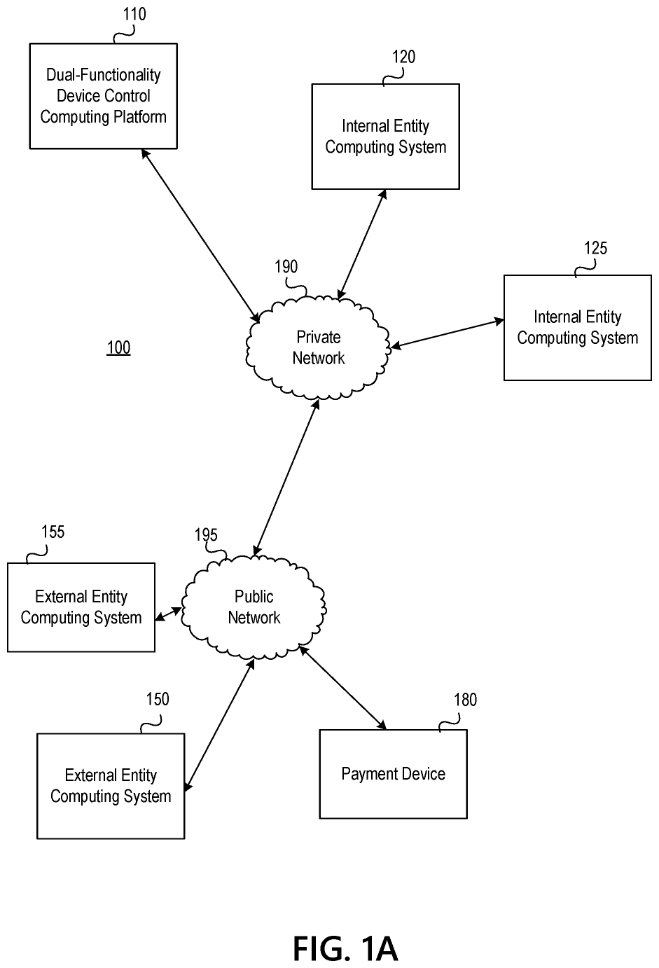

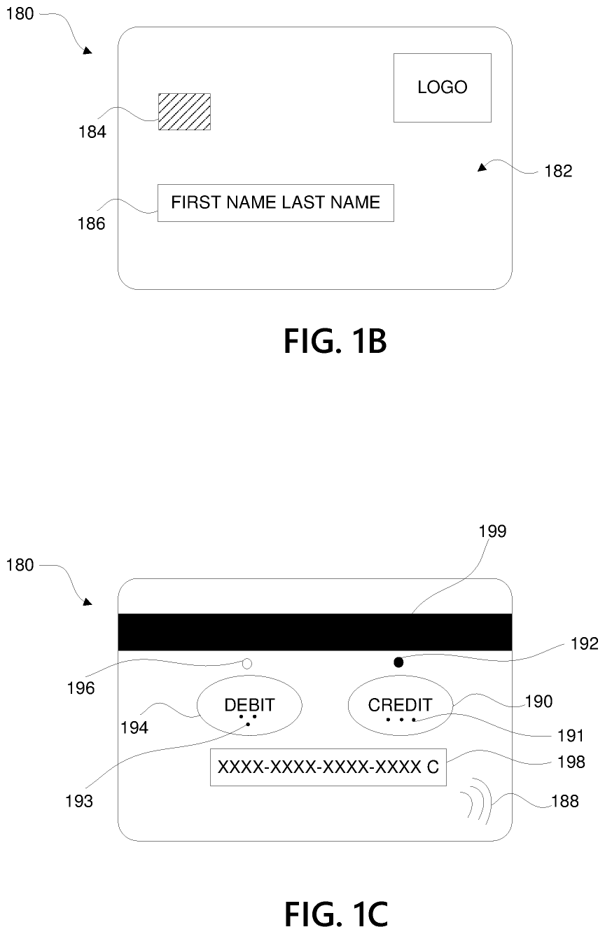

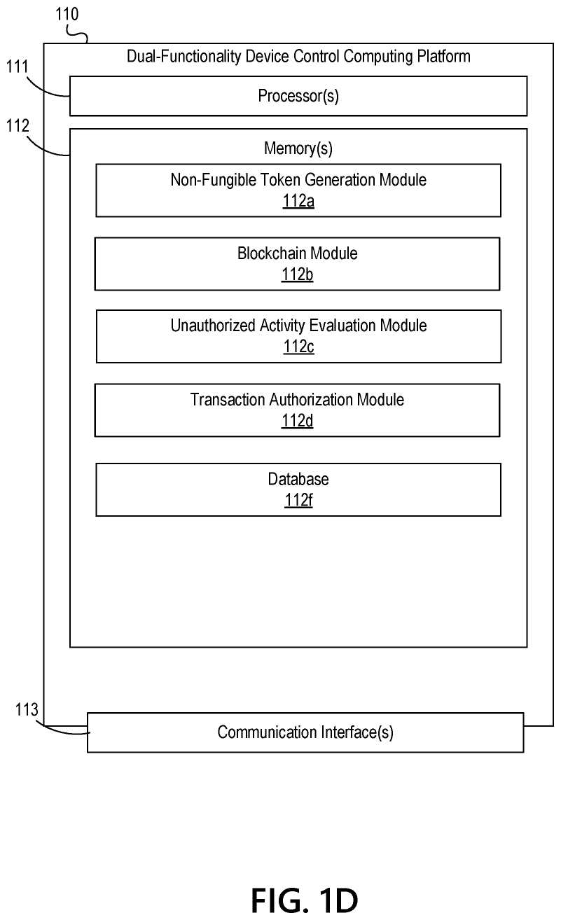

FIGS. 1A-1B depict an illustrative computing environment for implementing dynamic, real-time device functionality modification in accordance with one or more aspects described herein. Referring to FIG. 1A, computing environment 100 may include one or more computing devices and/or other computing systems. For example, computing environment 100 may include dual-functionality device control computing platform 110, internal entity computing system 120, internal entity computing system 125, external entity computing system 150, external entity computing system 155, and/or payment device 180. Although two internal entity computing systems 120, 125, two external entity computing systems 150, 155, and one payment device 180 are shown, any number of systems or devices may be used without departing from the invention.

Dual-functionality device control computing platform 110 may be configured to perform intelligent, dynamic, real-time device functionality modification. For instance, dual functionality device control computing platform 110 may be configured to receive a request to process a transaction. For instance, in some examples, the request to process the transaction may include a selection, by a user, of a mode of functionality (e.g., debit or credit) of the payment device. In some examples, the selection of the mode may be made by selecting an option of two or more available options provided on the payment device 180.

Upon receiving the request, dual-functionality device control computing platform 110 may generate a non-fungible token including, for example, a device identifier for the transaction. For instance, a 16-digit device identifier may be dynamically generated in real-time for use in processing the transaction. Accordingly, in some examples, the payment device might not include a static device identifier and, instead, may use the dynamically generated NFT as the device identifier to process the transaction. In some examples, the NFT may include a flag indicating a selected mode of functionality (e.g., debit or credit). In some arrangements, the flag may be separate from the NFT. The dynamically generated device identifier may be stored as an NFT in a blockchain of the enterprise organization. Accordingly, the blockchain may also store a user identifier associated with the payment device 180 and the dynamically generated NFT to enable authorization of a transaction using the NFT.

In some examples, the generated NFT may be transmitted to the payment device for display on a display of the payment device.

In some examples, the payment device may then be used to further process the transaction by, for instance, connecting to an external entity computing system 150, such as a merchant point-of-sale system (POS). For instance, a user may swipe the card, connect via near-field communication, insert a card into a card reader, or the like, to continue processing the transaction. The merchant POS may receive the NFT, flag indicating the selected mode of functionality (e.g., debit or credit), user identifier from, for instance, a smart chip on the payment device (e.g., a SIM enabled chip including user identifying data, data associated with the user relationship with the enterprise organization, and the like), and, in some examples, geo-location data. In some examples, at least the NFT data may be encrypted and all data may be transmitted to, for instance, the dual-functionality device control computing platform 110 or other institution for processing.

Dual functionality device control computing platform 110 may decrypt the received encrypted data and verify authenticity by using the user identifier to determine whether the NFT was an NFT generated for that user or payment device. In some examples, geo-location data may be used to verify that unauthorized activity is not occurring based on historical data, expected location data, geo-location data of the POS, or the like.

If the data is verified/validated, the transaction may be processed. For instance, dual-functionality device control computing platform 110 may process the transaction (e.g., transmit an instruction to update an account balance, account ledger and the like to one or more systems, transmit an instruction to process the transaction to one or more external entities, or the like).

In some examples, a transaction output may be generated (e.g., transaction successful/unsuccessful). The transaction output may be transmitted to the merchant POS (e.g., external entity computing system 150) for further processing. The transaction output may be transmitted to the payment device and displayed on a display screen of the payment device.

Computing environment 100 may further include internal entity computing system 120 and/or internal entity computing system 125 that may be or include one or more computing systems, devices, or the like, that may host or execute one or more applications of an enterprise organization. For instance, internal entity computing system 120 and/or internal entity computing system 125 may host or execute one or more applications in use by an enterprise organization (e.g., to process transactions, open new accounts, and the like). In some examples, internal entity computing system 120 and/or internal entity computing system 125 may store user data, account data, and the like. In some arrangements, internal entity computing system 120 and/or internal entity computing system 125 may store real time account balance data that may be retrieved by dual-functionality device control computing platform 110 to determine whether a requested transaction may be authorized (e.g., whether an account includes a sufficient balance, whether a credit limit is sufficient, or the like).

In some examples, internal entity computing system 120 and/or internal entity computing system 125 may include one or more databases having tables storing user or party identifiers and storing dynamically generated NFTs to confirm validity of a received NFT.

External entity computing system 150 and/or external entity computing system 155 may be or include one or more merchant or other external entity systems, such as a point-of-sale system used to process transactions. In some examples, external entity computing system 150 and/or external entity computing system 155 may include one or more transaction processing terminals that may connect to or otherwise communicate with a payment device 180 to process a transaction.

In some arrangements, one or more of external entity computing system 150 and/or external entity computing system 155 may include an external entity transaction processing system or service. For instance, external entity computing system 150 and/or external entity computing system 155 may be associated with one or more financial institutions other than the enterprise organization, one or more credit card providers, or the like. Accordingly, upon authorizing a transaction, in some examples, instructions to process a transaction may be sent or transmitted to one or more of external entity computing system 150 and/or external entity computing system 155 for processing.

Aspects discussed herein may be used with various payment devices, such as debit cards, credit cards, or the like. FIGS. 1B and 1C illustrate front and back views, respectively, of one example payment device 180 that may be used in accordance with one or more aspects described herein. For instance, FIG. 1B illustrates a front view of payment device 180, while FIG. 1C illustrates an opposite or rear view of the payment device 180.

In some examples, the payment device 180 may include a generally planar region 182 including payment processing components, such as a user name region 186, smart chip 184, near field communication 188, magnetic data strip 199, and the like. In some examples, the payment device 180 may include selectable buttons or options 190, 194 for a user to select a type of functionality (e.g., debit 194 or credit 190). For instance, the payment device 180 may include a selectable option or button 194 for the user to select when debit functionality is desired and a selectable option or button 190 for the user to select when credit functionality is desired. In some examples, the payment device 180 may include at least two selectable options. In some arrangements, the selectable options on payment device 180 may include a haptic region 191, 193 that may enable selection of an option for visually impaired users (e.g., raised indicators identifying the debit option 193 and credit option 191). In some examples, each selectable option may be associated with a visual indicator 192, 196 that may illuminate when the option is selected. For instance, as shown in FIG. 1C, visual indicator 192 is filled indicating that the indicator 192 is illuminated to note that a credit option is selected. In some examples, each visual indicator may illuminate in a different color to provide simplified differentiation to a user of the selected mode of functionality or processing.

Further, in some examples, the payment device 180 may include a display screen or region 198. The display screen 198 may be used to provide a visual indication of a dynamically generated device identifier (e.g., XXXX-XXXX-XXXX-XXXX C). In some examples, the “C” may be a flag indicating that credit has been selected. In some examples, the dynamically generated device identifier may be a non-fungible token. In some examples, the display screen 198 may also be used to provide a visual indication of whether a requested transaction was successfully processed, and/or may provide additional notifications to the user (e.g., low balance on account, or the like).

As mentioned above, computing environment 100 also may include one or more networks, which may interconnect one or more of dual-functionality device control computing platform 110, internal entity computing system 120, internal entity computing system 125, external entity computing system 150, external entity computing system 155, and/or payment device 180. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, dual-functionality device control computing platform 110, internal entity computing system 120, and/or internal entity computing system 125, may be associated with an enterprise organization (e.g., a financial institution), and private network 190 may be associated with and/or operated by the organization, and may include one or more networks (e.g., LANs, WANs, virtual private networks (VPNs), or the like) that interconnect dual-functionality device control computing platform 110, internal entity computing system 120, and/or internal entity computing system 125, and one or more other computing devices and/or computer systems that are used by, operated by, and/or otherwise associated with the organization. Public network 195 may connect private network 190 and/or one or more computing devices connected thereto (e.g., dual-functionality device control computing platform 110, internal entity computing system 120, internal entity computing system 125) with one or more networks and/or computing devices that are not associated with the organization. For example, external entity computing system 150, external entity computing system 155, and/or payment device 180, might not be associated with an organization that operates private network 190 (e.g., because external entity computing system 150, external entity computing system 155, and/or payment device 180 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 150, external entity computing system 155, and/or payment device 180 to private network 190 and/or one or more computing devices connected thereto (e.g., dual-functionality device control computing platform 110, internal entity computing system 120, internal entity computing system 125).

Referring to FIG. 1D, dual-functionality device control computing platform 110 may include one or more processors 111, memory 112, and communication interface 113. A data bus may interconnect processor(s) 111, memory 112, and communication interface 113. Communication interface 113 may be a network interface configured to support communication between dual-functionality device control computing platform 110 and one or more networks (e.g., private network 190, public network 195, or the like). Memory 112 may include one or more program modules having instructions that when executed by processor(s) 111 cause dual-functionality device control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of dual-functionality device control computing platform 110 and/or by different computing devices that may form and/or otherwise make up dual-functionality device control computing platform 110.

For example, memory 112 may have, store and/or include device identifier or non-fungible token generation module 112a. Device identifier or non-fungible token generation module 112a may store instructions and/or data that may cause or enable the dual-functionality device control computing platform 110 to receive an indication of transaction initiation including selection of a mode of functionality of the payment device 180 being used to process the transaction. For instance, a user may select a mode of functionality of the payment device (e.g., debit or credit) by select an option associated with each mode on the payment device 180. The selection may be transmitted to the dual-functionality device control computing platform 110 and that may cause generation of a dynamically generated device identifier that, in some examples, may be a non-fungible token stored in a blockchain. The device identifier/non-fungible token generation module 112a may transmit the generated non-fungible token or device identifier to the payment device 180 for display by a display of the payment device 180 and for use in authorizing a requested transaction. As discussed herein, the dynamically generated NFT may be available and active for a predetermined time period and may expire and no longer be available if not used within the predetermined time period. The dynamically generated NFT/device identifier may also be for one-time or single use such that, upon being used to process a transaction, the NFT may be deleted from the payment device 180 and a new NFT/device identifier may be generated to process a subsequent transaction.

Dual-functionality device control computing platform 110 may further have, store and/or include a blockchain module 112b. Blockchain module 112b may store instructions and/or data that may cause or enable the dual-functionality device control computing platform 110 to store generated NFTs in a blockchain with a user identifier associated with the payment device 180 requesting the transaction and/or additional data. The NFT may then be used to authorize a transaction based on a received NFT and user identifier matching the NFT and user identifier stored in the blockchain.

Dual-functionality device control computing platform 110 may further have, store and/or include unauthorized activity evaluation module 112c. Unauthorized activity evaluation module 112c may store instructions and/or data that may cause or enable the dual-functionality device control computing platform to receive geo-location data captured by the payment device 180 (e.g., via near-field communication) and compare the geo-location data to expected location data of a user (e.g., based on historical data, other real-time user data, or the like). Accordingly, the system may evaluate a requested transaction for unauthorized activity while determining whether the transaction is authorized and based on data received from the payment device 180.

Dual-functionality device control computing platform 110 may further have, store and/or include transaction authorization module 112d. Transaction authorization module 112d may store instructions and/or data that may cause or enable the dual-functionality device control computing platform 110 to receive an encrypted NFT and other data from a payment device 180 with transaction details and a request to process a payment. Transaction authorization module 112d may decrypt the NFT and compare the NFT and user identifier received with the request to a stored NFT and user identifier. In some examples, additional data such as account balance data, credit limit data, and the like, may be used to determine whether to authorize the requested transaction. The transaction authorization module 112d may then generate a transaction authorization output that may be transmitted to, for instance, a merchant POS, as well as to the payment device 180 for display on a display of the payment device 180.

Dual-Functionality device control computing platform 110 may further have, store and/or include a database 112e. Database 112e may store historical data related to previously processed transactions, data related to expected location of a user, and the like. Additional data may be stored in database 112f without departing from the invention.

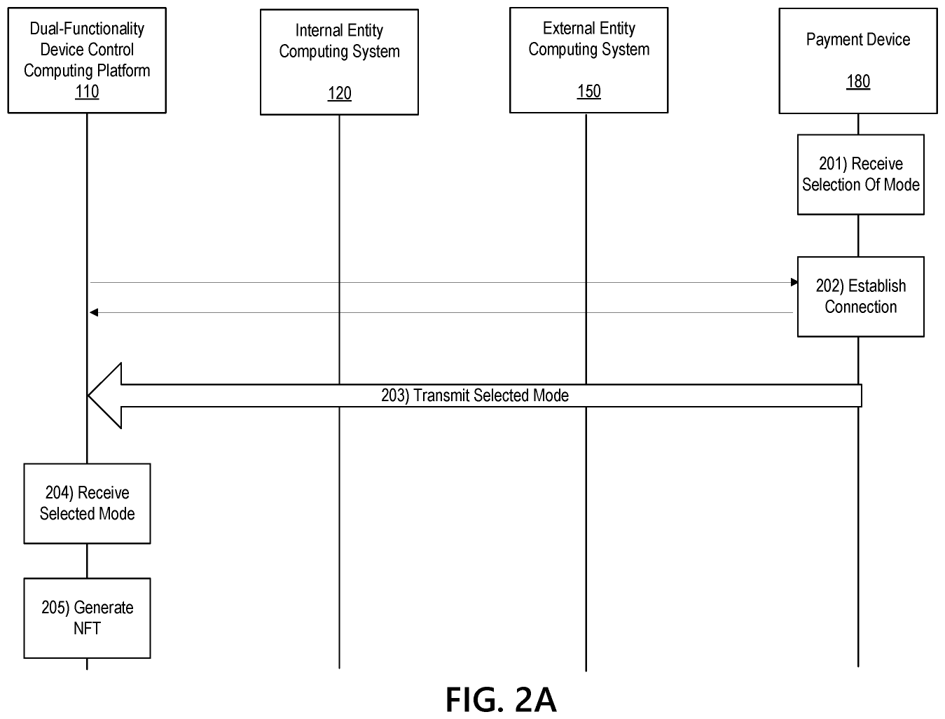

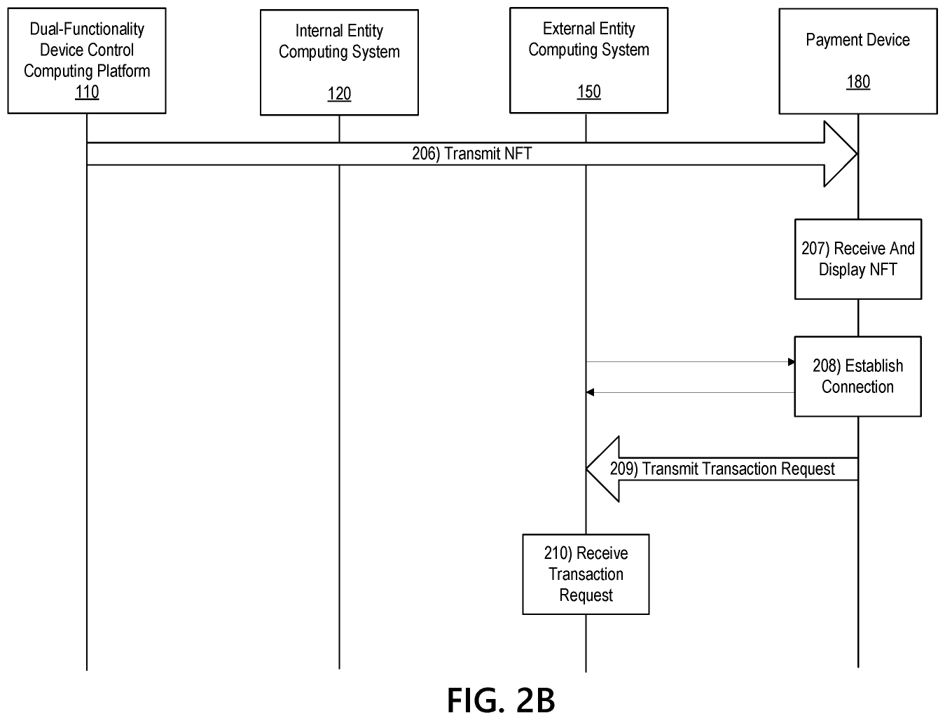

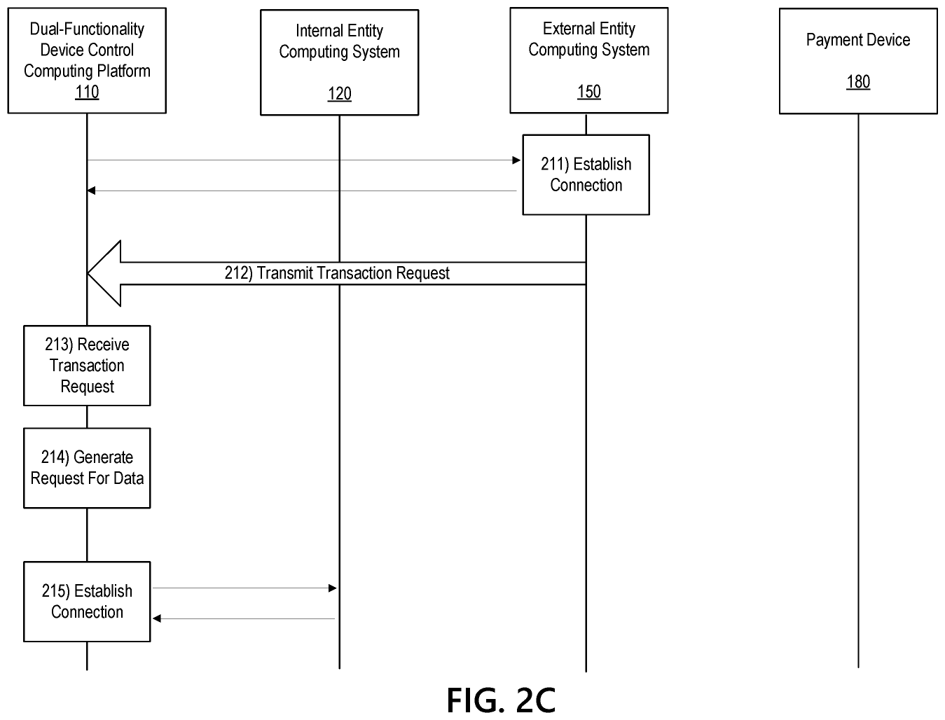

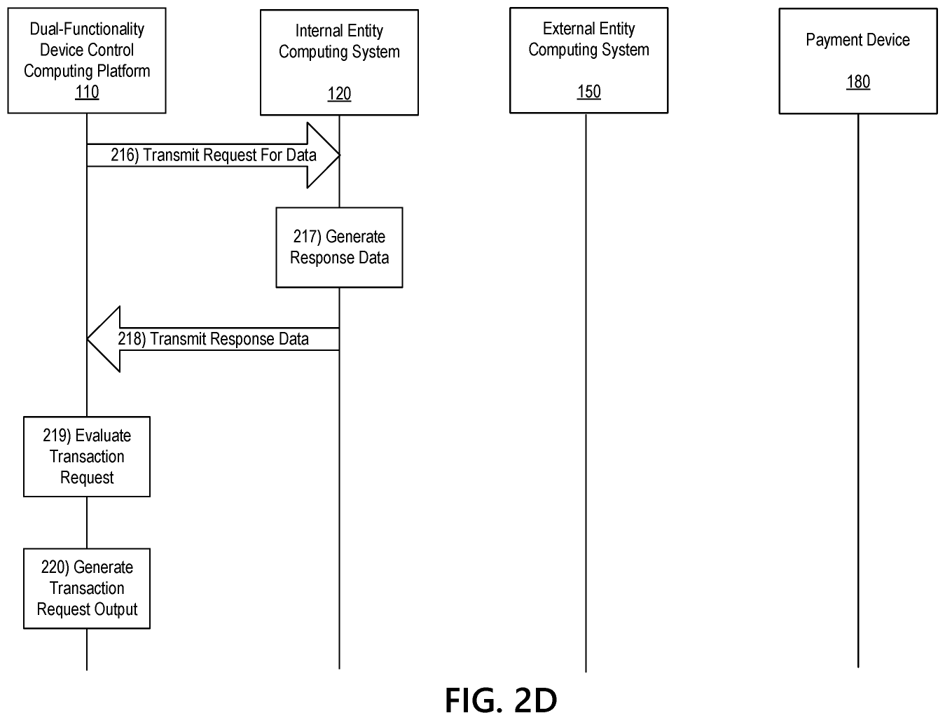

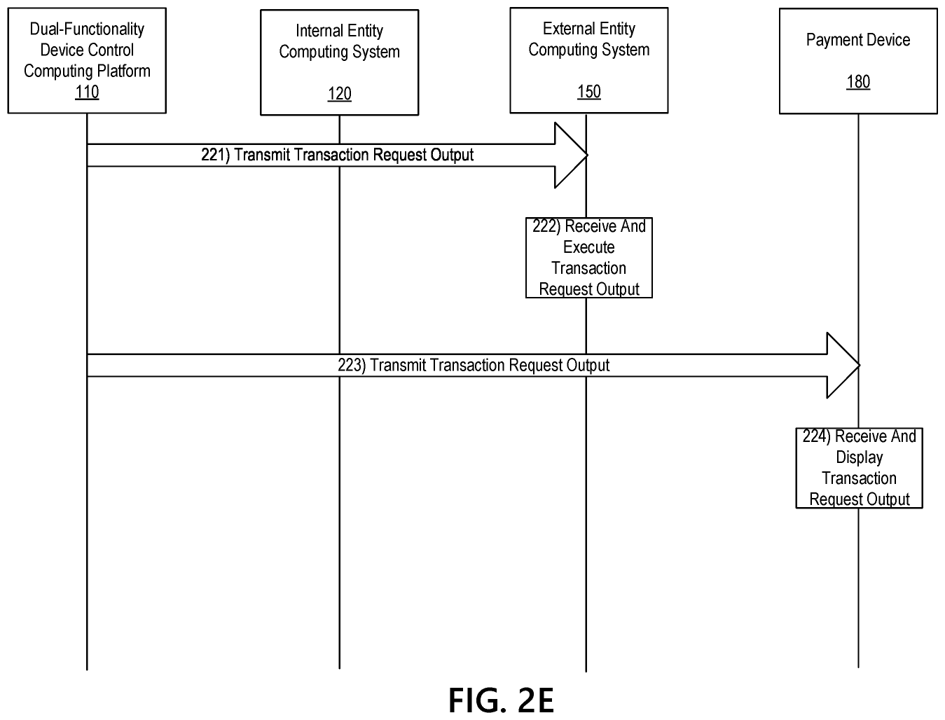

FIGS. 2A-2E depict one example illustrative event sequence for implementing software analysis functions in accordance with one or more aspects described herein. The events shown in the illustrative event sequence are merely one example sequence and additional events may be added, or events may be omitted, without departing from the invention. Further, one or more processes discussed with respect to FIGS. 2A-2J may be performed in real-time or near real-time.

With reference to FIG. 2A, at step 201, payment device 180 may receive selection of a mode of functionality to be used for a transaction. For instance, a user may select one of debit or credit via the at least two selectable options on the payment device 180. In some examples, selection of a mode of functionality may cause an indicator associated with the selected mode to illuminate or otherwise indicate that the mode has been selected.

At step 202, payment device 180 may connect to dual-functionality device control computing platform 110. For instance, a first wireless connection may be established between payment device 180 and dual-functionality device control computing platform 110. Upon establishing the first wireless connection, a communication session may be initiated between payment device 180 and dual-functionality device control computing platform 110.

At step 203, payment device 180 may transmit or send the selected mode of functionality, or an indication of the selected mode of functionality, to the dual-functionality device control computing platform 110. For instance, the selected mode may be sent or transmitted during the communication session initiated upon establishing the first wireless connection.

At step 204, dual-functionality device control computing platform 110 may receive the selected mode of functionality from the payment device 180.

At step 205, a device identifier or non-fungible token may be dynamically generated. For instance, based on the selected mode of functionality, a NFT may be generated that may be used to process a transaction. In some examples, the NFT may include an alphanumeric string of characters. In some examples, the NFT may be a 16-digit string of numbers, similar to conventional credit card numbers. Further, the NFT may include a flag indicating the selected mode of functionality to be used to process the transaction. For instance, a “D” for debit or “C” for credit may be generated and/or included in the NFT (e.g., at an end of the string of dynamically generated characters). The dynamically generated device identifier/NFT may be stored in a blockchain and used for processing a transaction.

With reference to FIG. 2B, at step 206, dual-functionality device control computing platform 110 may transmit or send the dynamically generated device identifier/NFT to the payment device 180. For instance, the dynamically generated device identifier/NFT may be transmitted or sent during the communication session initiated upon establishing the first wireless connection. Alternatively, another connection may be made and another communication session may be initiated.

At step 207, payment device 180 may receive and display the dynamically generated device identifier/NFT on, for instance, a display region of the payment device 180. In some examples, the display region may display the string of characters of the NFT and, in at least some examples, the flag associated with the selected mode of functionality.

At step 208, payment device 180 may connect to external entity computing system 150, which may, for instance, be a merchant point-of-sale system. For instance, a second wireless connection may be established between payment device 180 and external entity computing system 150. Upon establishing the second wireless connection, a communication session may be initiated between payment device 180 and external entity computing system 150. In some examples, the connection may be established in response to external entity computing system 150 detecting the payment device 180 within a predefined proximity (e.g., via near-field communication), or via card swipe or insert into a chip reader.

At step 209, the payment device 180 may transmit or send a request to process a transaction to the external entity computing system 150. The request to process the transaction may be transmitted or sent during the communication session initiated upon establishing the second wireless connection. In some examples, the request to process the transaction may include a data packet including the dynamically generated device identifier/NFT, the flag (e.g., Boolean flag) indicating the selected mode of functionality, a user identifier retrieved from, for instance, a smart chip embedded in the payment device 180 and, in some examples, geo-location data indicating a current location of the payment device 180. In some examples, the user identifier may be a static data point providing identifying data of the user to the enterprise organization or entity processing the transaction. In some arrangements, the NFT may be encrypted prior to sending.

At step 210, external entity computing system 150 may receive the request to the process the transaction.

With reference to FIG. 2C, at step 211, external entity computing system 150 may connect to dual-functionality device control computing platform 110. For instance, a third wireless connection may be established between external entity computing system 150 and dual-functionality device control computing platform 110. Upon establishing the third wireless connection, a communication session may be initiated between external entity computing system 150 and dual-functionality device control computing platform 110.

At step 212, the transaction request received by the external entity computing system 150, as well as transaction details (e.g., amount of transaction, type of transaction, merchant or parties to the transaction, and the like), may be transmitted or sent to the dual-functionality device control computing platform 110. For instance, a data packet including the transaction request and associated transaction details may be transmitted or sent during the communication session initiated upon establishing the third wireless connection.

At step 213, dual-functionality device control computing platform 110 may receive the transaction request and transaction details and may process the request.

For instance, at step 214, dual-functionality device control computing platform 110 may generate a request to user data, such as account balance data, credit limit data, or the like to evaluate whether the user has a sufficient balance or credit to complete or process the transaction using the selected mode of functionality.

At step 215, dual-functionality device control computing platform 110 may connect to internal entity computing system 120. For instance, a fourth wireless connection may be established between dual-functionality device control computing platform 110 and internal entity computing system 120. Upon establishing the fourth wireless connection, a communication session may be initiated between dual-functionality device control computing platform 110 and internal entity computing system 120.

With reference to FIG. 2D, at step 216, the dual-functionality device control computing platform 110 may transmit or send the request for user data to the internal entity computing system 120. For instance, the request for user data may be transmitted or sent during the communication session initiated upon establishing the fourth wireless connection.

At step 217, internal entity computing system 120 may receive the request for user data and may generate user response data. For instance, internal entity computing system 120 may retrieve, for instance, real-time data related to user account balances, user credit limits, and the like. This data may be used to generate user response data.

At step 218, the internal entity computing system 120 may transmit or send the user response data to the dual-functionality device control computing platform 110.

At step 219, dual-functionality device control computing platform 110 may evaluate the request to process the transaction. For instance, dual-functionality device control computing platform 110 may decrypt the encrypted NFT received with the request for transaction and may compare the NFT and received user identifier to data stored in the blockchain including the dynamically generated NFT and associated user of the payment device to which the NFT is associated. If the NFT and user identifier received match the stored data, the dual-functionality device control computing platform 110 may consider whether the user has a sufficient account balance, credit limit, or the like (e.g., based on data received from internal entity computing system 120). If so, the transaction may be authorized. If not, the transaction may be denied and, in some examples, a reason for denial may be identified.

In some arrangements, dual-functionality device control computing platform 110 may determine whether unauthorized activity is occurring based, for instance, on the geo-location data received from the payment device 180. For instance, the geo-location data may be compared to expected location data, historical location data, recent location data, or the like, to determine whether the payment device 180 is being used by an unauthorized actor.

At step 220, a transaction request output may be generated. For instance, based on the evaluation of the transaction request (e.g., NFT and user data matching, limits being sufficient, or the like) a transaction request output may be generated. The transaction request output may include an indication that the transaction is authorized, that the transaction is not authorized, a reason the transaction is not authorized, or the like.

With reference to FIG. 2E, at step 221, the dual-functionality device control computing platform 110 may transmit or send the transaction request output to the external entity computing system 150 for further processing (e.g., to complete processing of the transaction, deny the transaction, or the like).

At step 222, external entity computing system 150 may receive and execute the transaction request output to complete processing of the transaction, deny the transaction, or the like.

At step 223, dual-functionality device control computing platform 110 may transmit or send the transaction request output to the payment device 180. In some examples, transmitting the transaction request output may cause the payment device 180 to display the transaction request output. At step 224, the payment device 180 may receive and display, on a display of the payment device, the transaction request output (e.g., an indication that the transaction is authorized or was processed, an indication of denial, a reason for denial, or the like).

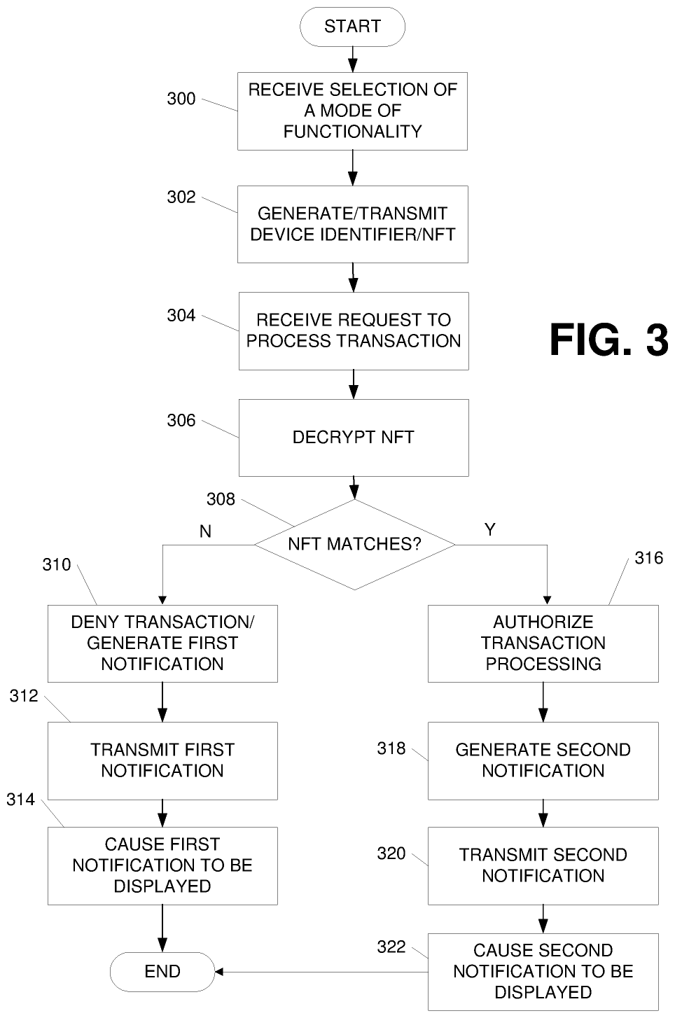

FIG. 3 is a flow chart illustrating one example method of implementing dual-functionality device control functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a selection of a mode of functionality or processing a transaction may be received from a dual-functionality payment device. For instance, a payment device, similar to a debit or credit card, may include selectable options associated with at least two different modes of functionality or processing. Accordingly, a user may select a mode of functionality or processing (e.g., debit or credit) on-the-fly based on different circumstances of a transaction being processed (e.g., credit for larger dollar transactions, debit or purchases under $5, or the like). Accordingly, the user may select, via one of the selectable options on the payment device, a desired mode of processing or functionality and that selection may be transmitted to, for instance, dual-functionality device control computing platform 110.

At step 302, dual-functionality device control computing platform 110 may, in response to receive the selected mode of processing or functionality, dynamically generate a device identifier that may be or include a non-fungible token. The dynamically generated device identifier/NFT may include an alphanumeric string of characters. In some examples, it may include a flag indicating the selected mode of processing/functionality (e.g., “D” for debit, “C” for credit, or the like). In some examples, the NFT may be active for a predetermined time period (e.g., a transaction must be completed using the NFT in a predetermined time or the NFT will expire and no longer be active). The dynamically generated device identifier/NFT may be transmitted to the payment device 180 from which the selection was received. In some examples, transmitting the NFT may cause the NFT to display on a display of the payment device.

At step 304, a request to process a transaction may be received. For instance, a user may initiate, via the payment device, using the NFT, and with an external entity computing system 150, such as a merchant POS, a transaction. A request to process the transaction may then be transmitted to the dual-functionality device control computing platform 110. For instance, an encrypted version of the NFT, the flag associated with the selected mode of processing or functionality, a user identifier retrieved from, for instance, a smart chip on the payment device 180, and, in some examples, geo-location data may be received. In some examples, transaction details such as amount, type, and the like, may be received.

At step 306, the encrypted NFT may be decrypted, e.g., by the dual-functionality device control computing platform 110.

At step 308, a determination may be made as to whether the decrypted NFT is associated with the user identifier received with the request for transaction. For instance, the decrypted NFT and received user identifier (e.g., extracted from the smart chip on the payment device 180) may be compared to the generated NFT and associated user data stored when the NFT was dynamically generated. If the data does not match (e.g., NFT does not match, NFT is not associated with received user identifier, or the like), the request to process the transaction may be denied and a first notification may be generated 310.

At step 312, the first notification may be transmitted to one or more devices. For instance, the first notification, which may include an indication that the requested transaction was not authorized or was denied, may be transmitted to the external entity computing system 150 from which the request was received. Further, the first notification may be transmitted to the payment device 180 that initiated the transaction request. In some examples, transmitting the first notification may cause the first notification to be displayed on a display of the payment device 180.

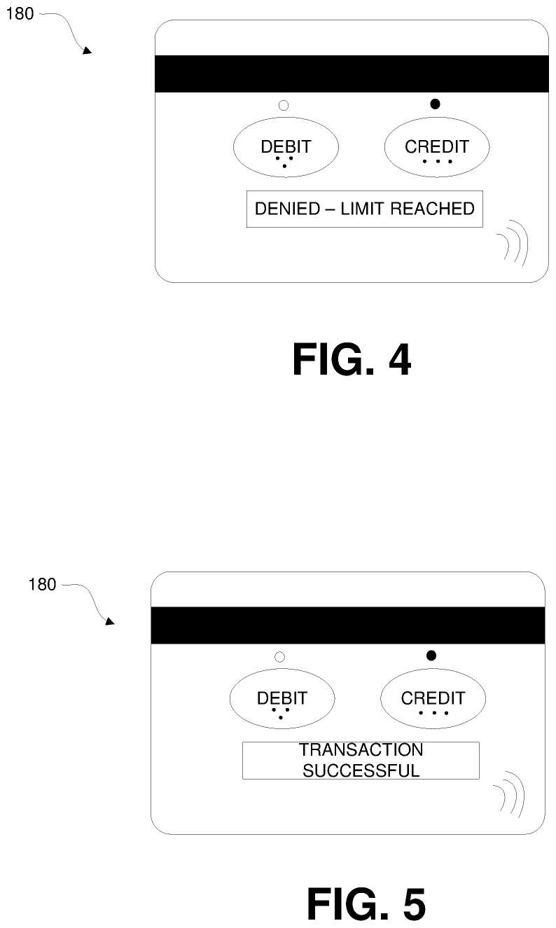

At step 314, the first notification may be displayed. For instance, FIG. 4 illustrates one example payment device 180 that may display an indication that the requested transaction was denied. In some examples, the display may also include a reason that the transaction was denied. For instance, in examples in which addition data related to user account balance, credit limit, or the like, is used to determine whether the transaction is authorized, an indication of a reason such as a credit limit has been reached, or a balance is too low may be provided to the user.

If, at step 308, the data does match (e.g., NFT matches stored NFT, NFT is associated with received user identifier, or the like), the request to process the transaction may be authorized at step 316. At step 318, a second notification may be generated indicating that the requested transaction is authorized for processing.

At step 320, the second notification may be transmitted to one or more devices. For instance, the second notification, which may include an indication that the requested transaction was authorized for processing, may be transmitted to the external entity computing system 150 from which the request was received and for further processing/completion of the transaction. Further, the second notification may be transmitted to the payment device 180 that initiated the transaction request. In some examples, transmitting the second notification may cause the second notification to be displayed on a display of the payment device 180.

At step 322, the second notification may be displayed. For instance, FIG. 5 illustrates one example payment device 180 that may display an indication that the requested transaction was authorized for processing, was successful, or the like.

Accordingly, aspects described herein provide for real-time dynamic modification of payment device functionality. The arrangements described provide secure debit or credit based transactions that rely on use of a single payment device having multiple options available for selection on the device. Accordingly, a user can select, on-the-fly, a mode of processing or functionality for use via the card, without having to carry multiple cards having different functionality or modes of processing.

For instance, users often choose a debit transaction to withdraw cash, to avoid debt, to make small dollar amount purchases (e.g., at merchants that may not accept credit for transactions below a predetermined dollar amount), to shop at stores that do not accept credit, to obtain cash back, to avoid higher service charges in person-to-person payments, and the like. Alternatively, users may choose a credit transaction to improve their credit standing, to finance a purchase, to earn rewards, to be protected from unauthorized activity, to obtain other benefits associated with a credit card (e.g., rental car protection, to more efficiently handle holds placed on a card by a merchant, and the like). The dual-functionality single payment device described herein enables user to quickly and efficiently toggle between credit and debit transactions based on their current desires or needs.

Further, by dynamically generating a random device identifier that may be or include a non-fungible token stored in a blockchain, the transactions processed using the dual-functionality payment device may be secure and may ensure secure authentication of a user and authorization of transactions.

As discussed herein, the dynamically generated device identifier or NFT may include a Boolean flag indicating a selected mode of functionality or processing. This may enable various enterprise organizations (e.g., financial institutions other than the enterprise organization implementing the systems and aspects described herein, credit card providers other than the enterprise organization described herein, and the like) to accurately and efficient process transactions made using the dual-functionality payment device.

Further, as discussed herein, the display provided on the payment device may enable the system to provide additional information to users. For instance, rather than just receiving an indication that a transaction was declined or failed, as in conventional systems, the display of the payment device described herein may provide additional information as to the reason the transaction was unsuccessful or declined. Accordingly, the user can take targeted action to rectify any issues.

As discussed, aspects described herein may occur or be performed in real-time or near real-time to enable efficient transaction processing.

Although aspects described herein are directed to processing transactions at, for instance, a merchant site, arrangements described herein may be used to process transactions at for instance, automated teller machines (ATMs), and the like.

Aspects described herein may enable processing of transactions using dynamically selected modes of functionality or processing via a single payment device. In some examples, the requested transaction may be processed by enterprise organization (e.g., financial institution) implementing the arrangements described herein. Additionally or alternatively, the transaction may be processed by an external entity (e.g., another financial institution, a credit card service provider, or the like). In those arrangements, transaction authorization may be transmitted to the other entity to complete processing of the transaction (e.g., after authorization has been performed by the enterprise organization based on the dynamically generated NFT) using, for instance, various transaction processing techniques.

Although aspects described herein include two selectable options shown on the payment device, more selectable options may be provided without departing from the invention. For instance, additional credit cards or user accounts may be linked to the card and selection of those different credit cards or accounts may be performed by selecting an option on the payment device. In some examples, users may select different cards having different reward options by selecting options on the payment device. Additionally or alternatively, the payment device may provide selectable options for selecting different rewards to receive for a same account (e.g., accounts having dynamically selectable reward options).

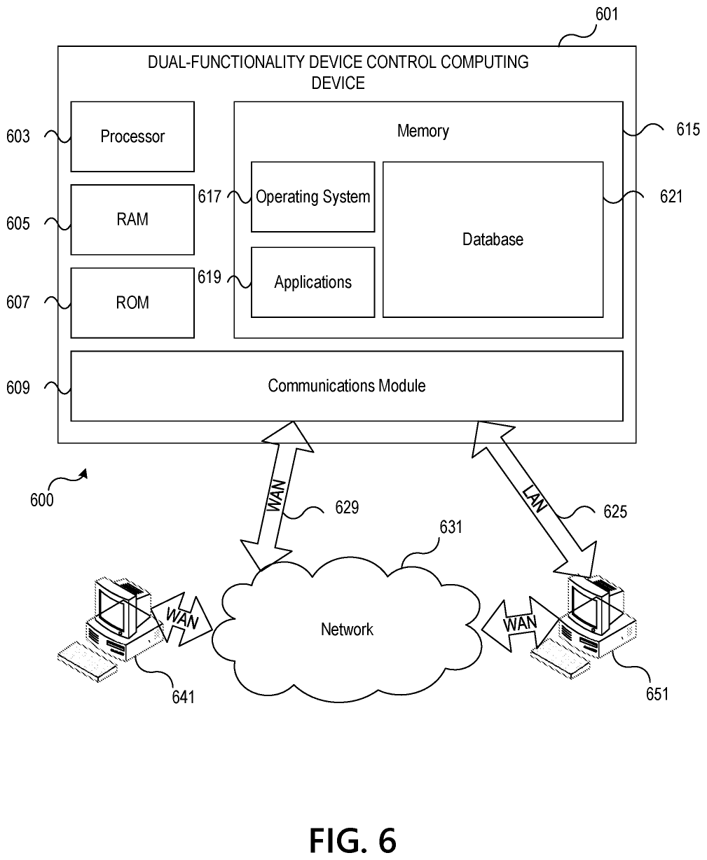

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include dual-functionality device control computing device 601 having processor 603 for controlling overall operation of dual-functionality device control computing device 601 and its associated components, including Random Access Memory (RAM) 605, Read-Only Memory (ROM) 607, communications module 609, and memory 615. Dual-functionality device control computing device 601 may include a variety of computer readable media. Computer readable media may be any available media that may be accessed by device performance evaluation computing device 801, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by dual-functionality device control computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on dual-functionality device control computing device 601. Such a processor may execute computer-executable instructions stored on a computer-readable medium.

Software may be stored within memory 615 and/or storage to provide instructions to processor 603 for enabling dual-functionality device control computing device 601 to perform various functions as discussed herein. For example, memory 615 may store software used by dual-functionality device control computing device 601, such as operating system 617, application programs 619, and associated database 621. Also, some or all of the computer executable instructions for dual-functionality device control computing device 601 may be embodied in hardware or firmware. Although not shown, RAM 605 may include one or more applications representing the application data stored in RAM 605 while dual-functionality device control computing device 601 is on and corresponding software applications (e.g., software tasks) are running on dual-functionality device control computing device 601.

Communications module 609 may include a microphone, keypad, touch screen, and/or stylus through which a user of dual-functionality device control computing device 601 may provide input, and may also include one or more of a speaker for providing audio output and a video display device for providing textual, audiovisual and/or graphical output. Computing system environment 600 may also include optical scanners (not shown).

Dual-functionality device control computing device 601 may operate in a networked environment supporting connections to one or more remote computing devices, such as computing devices 641 and 651. Computing devices 641 and 651 may be personal computing devices or servers that include any or all of the elements described above relative to dual-functionality device control computing device 601.

The network connections depicted in FIG. 6 may include Local Area Network (LAN) 625 and Wide Area Network (WAN) 629, as well as other networks. When used in a LAN networking environment, dual-functionality device control computing device 601 may be connected to LAN 625 through a network interface or adapter in communications module 609. When used in a WAN networking environment, dual-functionality device control computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, from a payment device having options to provide at least two different modes of processing, a selection of a mode of processing of the at least two different modes of processing;
responsive to receiving the selection, dynamically generate a non-fungible token;
transmit the non-fungible token to the payment device, wherein transmitting the non-fungible token to the payment device causes the non-fungible token to display on a display of the payment device;
receive, from the payment device and via an external entity computing device, a request to process a transaction, the request to process the transaction including an encrypted version of the non-fungible token, a flag indicating the selected mode of processing and a user identifier associated with the payment device;
decrypt the encrypted version of the non-fungible token;
determine whether the non-fungible token is associated with the user identifier associated with the payment device;
responsive to determining that the non-fungible token is not associated with the user identifier associated with the payment device:
generate a first notification; and
transmit the first notification to the payment device, wherein transmitting the first notification to the payment device causes the first notification to be displayed by the display of the payment device;
responsive to determining that the non-fungible token is associated with the user identifier associated with the payment device:
authorize processing of the transaction;
generate a second notification indicating that the transaction was authorized for processing; and
transmit the second notification to the payment device, wherein transmitting the second notification to the payment device causes the second notification to be displayed on the display of the payment device.

2. The computing platform of claim 1, wherein the request to process the transaction further includes geo-location data of the payment device.

3. The computing platform of claim 2, wherein the geo-location data is captured via near-field communication of the payment device.

4. The computing platform of claim 2, further including instructions that, when executed, cause the computing platform to:
evaluate the transaction for unauthorized activity based on the geo-location data.

5. The computing platform of claim 1, wherein the at least two different modes of processing include debit and credit.

6. The computing platform of claim 1, wherein the dynamically generated non-fungible token includes an alphanumeric string of characters.

7. The computing platform of claim 1, wherein the dynamically generated non-fungible token is valid for a predetermined amount of time.

8. A method, comprising:
receiving, by a computing platform, the computing platform having at least one processor, and memory, and from a payment device having options to provide at least two different modes of processing, a selection of a mode of processing of the at least two different modes of processing;
responsive to receiving the selection, dynamically generating, by the at least one processor, a non-fungible token;
transmitting, by the at least one processor, the non-fungible token to the payment device, wherein transmitting the non-fungible token to the payment device causes the non-fungible token to display on a display of the payment device;
receiving, by the at least one processor, from the payment device and via an external entity computing device, a request to process a transaction, the request to process the transaction including an encrypted version of the non-fungible token, a flag indicating the selected mode of processing and a user identifier associated with the payment device;
decrypting, by the at least one processor, the encrypted version of the non-fungible token;
determining, by the at least one processor, whether the non-fungible token is associated with the user identifier associated with the payment device;
when it is determined that the non-fungible token is not associated with the user identifier associated with the payment device:
generate, by the at least one processor, a first notification; and
transmit, by the at least one processor, the first notification to the payment device, wherein transmitting the first notification to the payment device causes the first notification to be displayed by the display of the payment device;
when it is determined that the non-fungible token is associated with the user identifier associated with the payment device:
authorize, by the at least one processor, processing of the transaction;
generate, by the at least one processor, a second notification indicating that the transaction was authorized for processing; and
transmit, by the at least one processor, the second notification to the payment device, wherein transmitting the second notification to the payment device causes the second notification to be displayed on the display of the payment device.

9. The method of claim 8, wherein the request to process the transaction further includes geo-location data of the payment device.

10. The method of claim 9, wherein the geo-location data is captured via near-field communication of the payment device.

11. The method of claim 9, further including:
evaluating, by the at least one processor, the transaction for unauthorized activity based on the geo-location data.

12. The method of claim 8, wherein the at least two different modes of processing include debit and credit.

13. The method of claim 8, wherein the dynamically generated non-fungible token includes an alphanumeric string of characters.

14. The method of claim 8, wherein the dynamically generated non-fungible token is valid for a predetermined amount of time.

15. One or more non-transitory computer-readable media storing instructions that, when executed by a computing platform comprising at least one processor, memory, and a communication interface, cause the computing platform to:
receive, from a payment device having options to provide at least two different modes of processing, a selection of a mode of processing of the at least two different modes of processing;
responsive to receiving the selection, dynamically generate a non-fungible token;
transmit the non-fungible token to the payment device, wherein transmitting the non-fungible token to the payment device causes the non-fungible token to display on a display of the payment device;
receive, from the payment device and via an external entity computing device, a request to process a transaction, the request to process the transaction including an encrypted version of the non-fungible token, a flag indicating the selected mode of processing and a user identifier associated with the payment device;
decrypt the encrypted version of the non-fungible token;
determine whether the non-fungible token is associated with the user identifier associated with the payment device;
responsive to determining that the non-fungible token is not associated with the user identifier associated with the payment device:
generate a first notification; and
transmit the first notification to the payment device, wherein transmitting the first notification to the payment device causes the first notification to be displayed by the display of the payment device;
responsive to determining that the non-fungible token is associated with the user identifier associated with the payment device:
authorize processing of the transaction;
generate a second notification indicating that the transaction was authorized for processing; and
transmit the second notification to the payment device, wherein transmitting the second notification to the payment device causes the second notification to be displayed on the display of the payment device.

16. The one or more non-transitory computer-readable media of claim 15, wherein the request to process the transaction further includes geo-location data of the payment device.

17. The one or more non-transitory computer-readable media of claim 16, wherein the geo-location data is captured via near-field communication of the payment device.

18. The one or more non-transitory computer-readable media of claim 16, further including instructions that, when executed, cause the computing platform to:
evaluate the transaction for unauthorized activity based on the geo-location data.

19. The one or more non-transitory computer-readable media of claim 15, wherein the at least two different modes of processing include debit and credit.

20. The one or more non-transitory computer-readable media of claim 15, wherein the dynamically generated non-fungible token includes an alphanumeric string of characters.

21. The one or more non-transitory computer-readable media of claim 15, wherein the dynamically generated non-fungible token is valid for a predetermined amount of time.
